(19) United States
(12) Patent Application Publication
(10) Pub. No.: US 2011/0063105 A1
(43) Pub. Date: Mar. 17, 2011

(54) EMERGENCY MESSAGE RELAY

(75) Inventors: James D. Bennett, Hroznetin (CZ); Jeyhan Karaoguz, Irvine, CA (US)

(73) Assignee: BROADCOM CORPORATION, Irvine, CA (US)

(21) Appl. No.: 12/698,012

(22) Filed: Feb. 1, 2010

Related U.S. Application Data
(60) Provisional application No. 61/242,985, filed on Sep. 16, 2009.

(51) Int. Cl. G08B 1/08

(52) U.S. Cl. 340/539.11

(57) ABSTRACT

A wireless device receives a first emergency message in a first communication protocol via a first wireless interface of the plurality of wireless interfaces from a transmitting wireless device, translates the first emergency message in the first communication protocol to a second emergency message in a second communication protocol, and transmits the second emergency message via a second wireless interface of the plurality of wireless interfaces to a network infrastructure. A wireless device requesting emergency service prepares one or more emergency messages based upon an emergency message direction received from a user, repeatedly transmits the at least one emergency message via one or more available wireless interfaces. Upon meeting a termination criteria, the wireless device ceases repeatedly transmitting the at least one emergency message via the at least one wireless interface.

### CROSS-REFERENCE TO PRIORITY APPLICATION

The present application claims priority to U.S. Provisional Application No. 61/242,985, filed Sep. 16, 2009, which is incorporated herein in its entirety for all purposes.

### BACKGROUND OF THE INVENTION

1. Field of the Invention

The present invention relates generally to emergency messaging, more particularly to devices and a wireless communication infrastructure delivering an emergency message.

2. Description of the Related Art

Emergency messages, e.g., SOS messages, are typically sent using a phone connection, e.g., 911 call via a Public Switched Telephone Network (PSTN) phone, a cellular telephone, a satellite phone, etc. A person in distress may not necessarily have access to a phone or he may not be in a position to place a SOS call. For example, a person using a media player may be in a traffic accident and may not have access to a phone to send an SOS message or otherwise to make an SOS call to obtain emergency services. While the media player may support Bluetooth or another wireless connection type it cannot access a cellular network for SOS messaging. Other handheld devices such as personal digital assistant (PDAs), networked computers such as laptops or palm top computers typically support Bluetooth and infrared communications but have no cellular phone connections or Wireless Wide Area Network (WWAN) connection. Further, while the user may also have access to a cellular phone, the cellular phone may be present in a geographic location that is not serviced. In such case, the cellular phone is also not available for use in sending an SOS message.

Another example of an emergency situation is when a person has a heart attack and is not able to send an SOS message due to incapacity, even though the person has a pacemaker that detects the heart attack. Similarly, a sphygmomanometer or a pulse rate measuring instrument or another medical device attached to a patient's body may determine that the person needs immediate attention. However these devices, which may have local wireless communications capabilities do not have networked phone connectivity and cannot be used for sending an SOS message.

There are situations where a generic SOS message sent from a phone is not sufficient to identify the location of the phone or the user of the phone. However, some phones may have a coupled GPS receiver, which locates the phone. While appending GPS coordinates to a SOS would make it easier and quicker for responders to locate the phone, infrastructure and messaging for such operations are not currently available and human intervention is required.

Further limitations and disadvantages of conventional and traditional approaches will become apparent to one of ordinary skill in the art through comparison of such systems with various aspects of the present invention.

### BRIEF SUMMARY OF THE INVENTION

The present invention is directed to apparatus and methods of operation that are further described in the following Brief Description of the Drawings, the Detailed Description, and the claims. Other features and advantages of the present invention will become apparent from the following detailed description of the invention made with reference to the accompanying drawings.

### BRIEF DESCRIPTION OF THE DRAWINGS

Aspects and teachings of the present invention will now be described for purposes of illustration and not limitation in conjunction with the following figures:

FIG. 1 is a system diagram illustrating a plurality of wireless devices and a network infrastructure operating according to one or more embodiments of the present invention;

FIG. 2 is a system diagram illustrating devices and a communication infrastructure supporting emergency message generation and relay according to one or more embodiments of the present invention;

FIG. 3 is a system diagram illustrating a system that supports emergency message generation and relay according to one or more embodiments of the present invention;

FIG. 4 is a flow chart illustrating operations according to one or more embodiments of the present invention;

FIG. 5 is a flow chart illustrating message translation operations according to one or more embodiments of the present invention;

FIG. 6 is a block diagram illustrating a wireless device that generates emergency messages according to one or more embodiment of the present invention; and

FIG. 7 is a block diagram illustrating a wireless or wired device that performs emergency message conversion according to one or more embodiments of the present invention.

### DETAILED DESCRIPTION

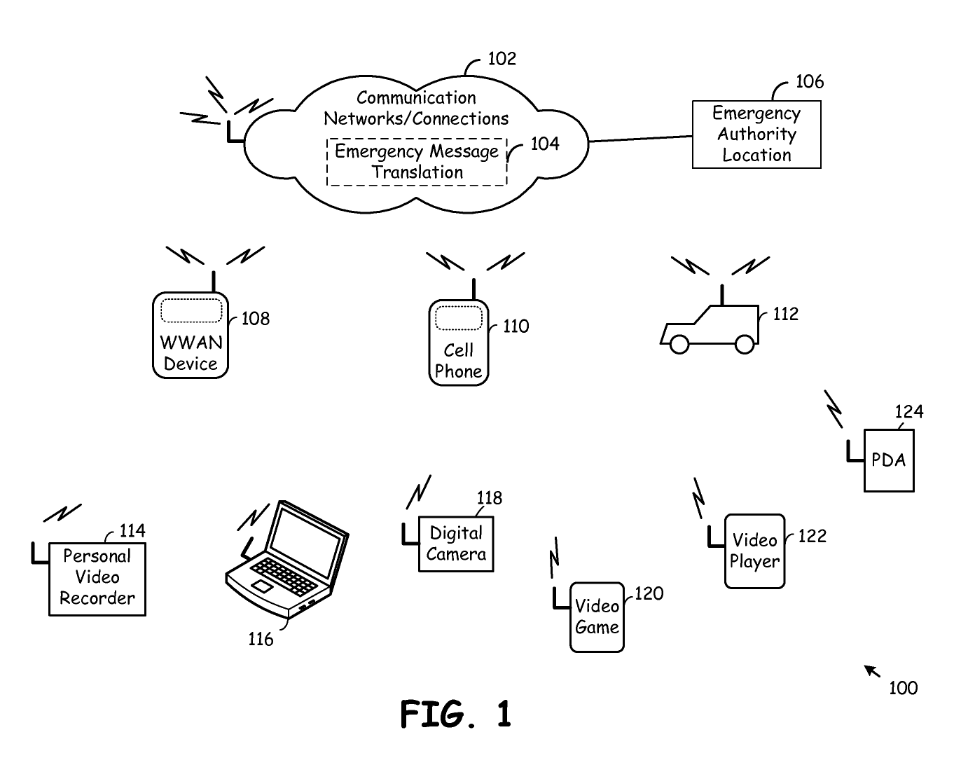

FIG. 1 is a system diagram illustrating a plurality of wireless devices and a network infrastructure operating according to one or more embodiments of the present invention. The system 100 of FIG. 1 includes a plurality of wireless devices that are capable of generating emergency messages (SOS messages). These wireless devices include a personal video recorder 114, a laptop computer 116, a digital camera 118, a video game player 120, a video player 122, and a Personal Data Assistant (PDA) 124. Each of these devices 114, 116, 118, 120, 122, and 124 supports the generation of an emergency message based upon an emergency message direction received from a user via a user interface to the device. Further, one or more of these devices 114, 116, 118, 120, 122, and 124 may be capable of generating an SOS message without user initiation, e.g., based upon accelerometer sensing, temperature sensing, accident recognition, or another technique. Upon initiation of SOS message operation functionality, each of these devices persistently transmits an emergency message via one or more of its wireless interfaces.

The example of the system 100 of FIG. 1, one or more of the wireless devices 114, 116, 118, 120, 122, and/or 124 does not have available thereto communication capability with communications network(s) 102. The communications network(s) 102 support one or more of Wireless Wide Area Network (WWAN) communications, cellular communications and/or satellite communications and have network connectivity with an emergency location authority location 106, e.g., police station, fire station, 911 location, third party emergency monitoring location, etc. However, WWAN device 108, cell phone 110, and WWAN/cell phone enabled vehicle 112 each have the capability of communicating with the communications network(s) 102. Thus, one or wireless devices 108, 110, and/or 112 serves as an SOS message relay device for one or more of the wireless devices 114, 116, 118, 120, 122, and 124.

In some embodiments, wireless devices 108, 110, and 112 include multiple wireless interfaces. A first one of these wireless interfaces, which may be a Wireless Personal Area Network (WPAN) interface, an infrared interface, a Wireless Local Area Network (WLAN) interface, a millimeter-wave (60 GHz) interface, or another type of wireless interface services communications with one or more of the wireless devices 114, 116, 118, 120, 122, and 124 and another commonly enabled communication device. For example, the personal video recorder 114, laptop computer 116, digital camera 118, video game 120, video player 122, or personal data assistant 124 may include a short-range communication interface suitable for the exchange of data with a proximately located device.

Wireless devices 108, 110, and 112 include both a first wireless interface operable to communicate with one or more of wireless devices 114, 116, 118, 120, 122, and/or 124 and include a second wireless interface operable to communicate with communications network 102. With these multiple wireless interfaces, wireless devices 108, 110, and 112 serve as SOS message relay devices. Further, with other embodiments, while one of wireless devices 114, 116, 118, 120, 122, or 124 includes a wireless interface capable of communicating with the communications network(s) 102, if such a wireless interface is unavailable (no service, out of battery power, broken, etc.), one of devices 108, 110, or 112 may serve as an SOS relay device for such other of devices 114, 116, 118, 120, 122, or 124.

In a typical operation according to the present invention, a user of the digital camera 118 is in an emergency situation. The user of the digital camera 118 may be in a car that is involved in a traffic accident, for example. The user requires emergency assistance that would be dispatched from an emergency authority location 106. However, because the digital camera 118 does not have communications connectivity with communications network 102, the digital camera 118 persistently and repeatedly transmits an emergency message via its available wireless interface(s), e.g., WPAN/Bluetooth interface. Vehicle 112 driving past the scene of the accident includes both a Bluetooth transceiver and a cellular network transceiver. The Bluetooth transceiver of the vehicle 112 receives one or more emergency messages transmitted by digital camera 118. Then, communication circuitry of the vehicle 112 relays the emergency message received from the digital camera 118 to the communications network 102 using a wireless interface capable of communicating with the communications network(s) 102.

In relaying the emergency message emanating from the digital camera 118 to the communications network 102, the vehicle 112 may translate the message from a format consistent with the WPAN/Bluetooth message to a format consistent with a cellular network/WWAN network/satellite network that is supported by the communications network 102. Alternately, emergency message translation 104 may occur within the communications network 102. In such, the communication circuitry of the vehicle 112 simply relays the emergency message received from the digital camera 118 to the communications network 102, emergency message translation function 104 translates the emergency message, and the translated message is forwarded to the emergency authority location 106.

Additional examples of the operations of the system of FIG. 1 include generation of emergency messages by any other of the devices 114, 116, 120, 122, and/or 124. Any of the WWAN device 108, the cell phone 110, or the vehicle 112 of FIG. 1 may serve to relay emergency messages between the communications network 102 and any of the source emergency message devices 114, 116, 120, 122, and/or 124. The operation of the system 100 of FIG. 1 may also include the relaying of an emergency message response emanating from the emergency authority location 106 and terminating at a source device, e.g., digital camera 118. In such case, the vehicle 112, which includes communications circuitry, may relay the emergency response message between the communications network(s) 102 and the digital camera 118. Alternately, the emergency response message may be relayed through the communications network and via another of the devices 108 or 110 to the digital camera 118. Upon receipt, the digital camera 118 may cease repeatedly transmitting the emergency message. With such operation, the emergency message translation component 104 of communications network(s) 102 may also be required to translate the emergency response message that the emergency authority location 106 produces.

The emergency message typically includes the identity of the source device, e.g., digital camera 118, may include information relating to the relaying device, e.g., 112. Additional location information relating to the emergency message may be generated using various techniques and appended to the emergency message. For example, using one technique, digital camera 118 has a Global Positioning System (GPS) contained therein. In such case, the emergency message generated by the digital camera 118 includes location coordinates based upon its GPS position. In such case, the emergency authority location 106 may then dispatch emergency services based upon the GPS location. Alternatively, the digital camera 118 may have no GPS receiver. In such case, a GPS receiver within vehicle 112 (or device 108 or 110) may be employed to append GPS location coordinates of the vehicle 112 to the emergency message before it is relayed to communications network 102 and to the emergency authority location 106 thereby. Moreover, the communications network 102 may determine a general location of vehicle 112 (and likewise digital camera 118) based upon a base station that receives the relayed communication from the vehicle 112 and append that location information to the emergency message.

According to another aspect of the present invention, additional information may be appended to the emergency message by one of the WWAN device 108, the cell phone 110, and/or the vehicle 112 in order to assist in the direction of emergency services. Such additional information may include the device type of digital camera 118, the wireless interface type used to communicate with digital camera 118, and/or other information pertinent to the dispatch of emergency services to render assistance to the user of the digital camera 118. For example, the digital camera 118 may take a picture that is appended to the emergency message.

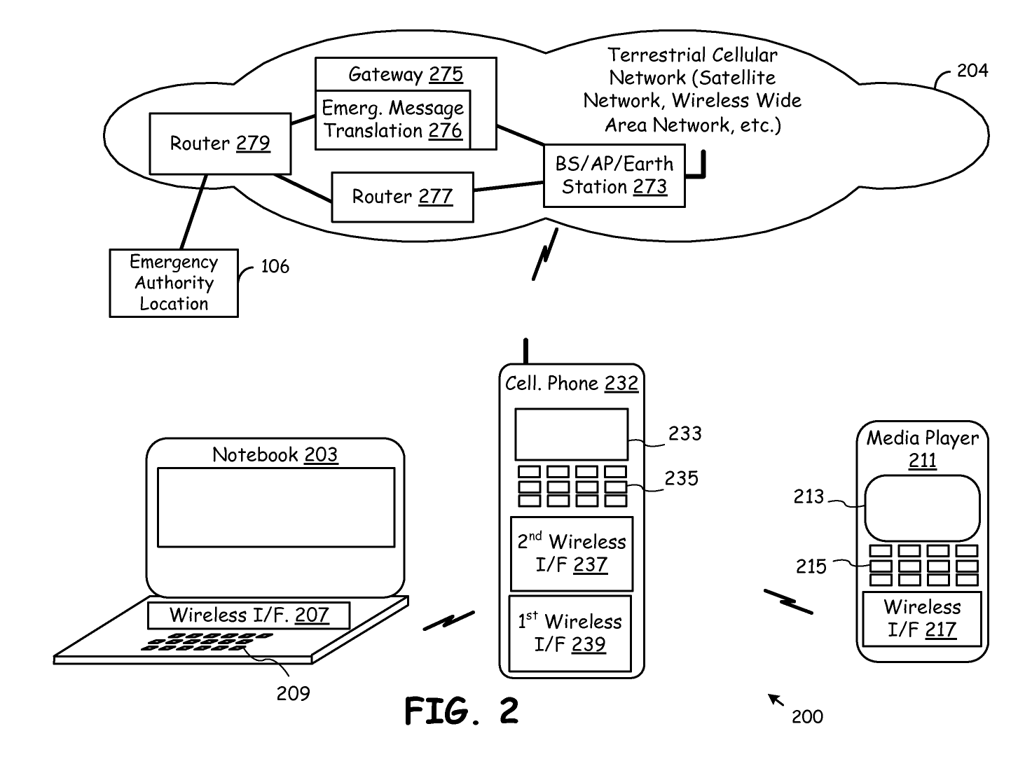

FIG. 2 is a system diagram illustrating devices and a communication infrastructure supporting emergency message generation and relay according to one or more embodiments of the present invention. The system 200 of FIG. 2 includes a notebook computer 203, cell phone 232, and a media player 211. Further shown in the system 200 of FIG. 2 are a communication infrastructure 204 and an emergency authority location 106.

The notebook computer 203 includes a wireless interface 207 and a keyboard 209 that is employed to receive input from a user to generate an emergency message direction. Likewise, media player 211 includes wireless interface 217, display 213, and keyboard 215. The keyboard 215 receives input from a user to generate an emergency message. Cell phone 232 includes display 233, keypad 235, a first wireless interface 239, a second wireless interface 237, and an antenna 242. The cell phone 232 wirelessly communicates with the terrestrial cellular network (satellite network, wireless wide area network, etc.) via a base station/access point/earth station 273. Thus, communications between cell phone 232 and base station 273 operate according to a particular communication protocol. This communication protocol may be one or more of a number of cellular telephony communication protocols supported according to currently and future communication standards, e.g., North American CDMA, North American TDMA, GSM, UMTS, WCDMA, etc. The cellular network 204 also includes a gateway 275 and routers 277 and 279. Emergency authority location 106 couples to router 279 which allows the emergency authority location 106 to be communicatively coupled to cell phone 232. Gateway 275 includes emergency message translation functionality 276.

According to a first operation according to the present invention, a user of notebook computer 203 desires emergency service. In such case, the user provides an emergency message direction to the notebook computer 203 via the keyboard 209. The notebook computer 203 prepares at least one emergency message based upon the emergency message direction received from the user. Notebook computer 203 then repeatedly and persistently transmits at least one emergency message via its wireless interface 207. Because this wireless interface 207 cannot access the terrestrial cellular network 204, it simply repeatedly transmits the emergency message via the wireless interface 207. Cell phone 232 includes a wireless interface 239 that is compatible to wireless interface 207 of the notebook computer 203 and a wireless interface 237 that is compatible with the terrestrial cellular network 204. The cell phone 232 receives the broadcast emergency message from the notebook computer 203 in a first communication protocol via the wireless interface 239. The format of this message may be a WPAN format, a WLAN format, a millimeter-wave/60 GHz format, a near field wave wireless communication format, an infrared wireless communication format, or another type of short communication range wireless format.

The cell phone 232 receives the first emergency message in the first communication protocol via the wireless interface 239 and translates the first emergency message in the first communication protocol to a second emergency message in a second communication protocol. The second communication protocol is consistent with the second wireless interface 237, which transmits the second emergency message in the second communication protocol to the terrestrial cellular network 204. The terrestrial cellular network, in other embodiments may be a WWAN network or a satellite network. Thus, the cell phone 232 serves to the relay emergency message(s) generated by notebook computer 203 to the cellular network 204, which then forwards the emergency message to the emergency authority location 106. The cellular network 204 may also translate the message from the format in which it is received to a format which the emergency authority location 106 using the emergency message translation functionality 276 of gateway 275.

Likewise, media player 211 may generate a first emergency message in a first communication protocol based upon user input received by keyboard 215. The media player 211 may interact with the user via the display 213 and the keyboard 215 in order to elicit additional information that will be included with the emergency message that it generates. After interacting with the user, the media player 211 produces a first emergency message in a first communication protocol format and repeatedly and persistently transmits the emergency message via the wireless interface 21. The media player 211 persistently transmits the first emergency message in the first communication protocol via the wireless interface 217 in order to maximize the probability that the emergency message will be received by another proximately located device. Because the media player 211 supports only short range wireless communications, there is no guaranty that any other device will be able to receive the transmitted emergency message. Thus, the media player 211 may continue to repeatedly transmit the emergency message via the wireless interface 217 until a termination event is reached. Such termination event may be met upon receipt of a response to the emergency message. However, the termination event may simply be when the media player 211 battery no longer has sufficient energy to transmit the emergency message. The termination event also could be met upon input by user when emergency service is rendered or when the emergency no longer exists.

According to aspects of the present invention therefore, the transmitted emergency message for the media player 211 is received by cell phone 232 which relays the emergency message to the cellular network 204 for subsequent delivery to emergency authority location 106. The cell phone 232 may translate the emergency message prior to forwarding the emergency message to the cellular network. Message translation may include appending additional information to the emergency message that is further used by the emergency authority location 106 to render service to the requesting user of media player 211.

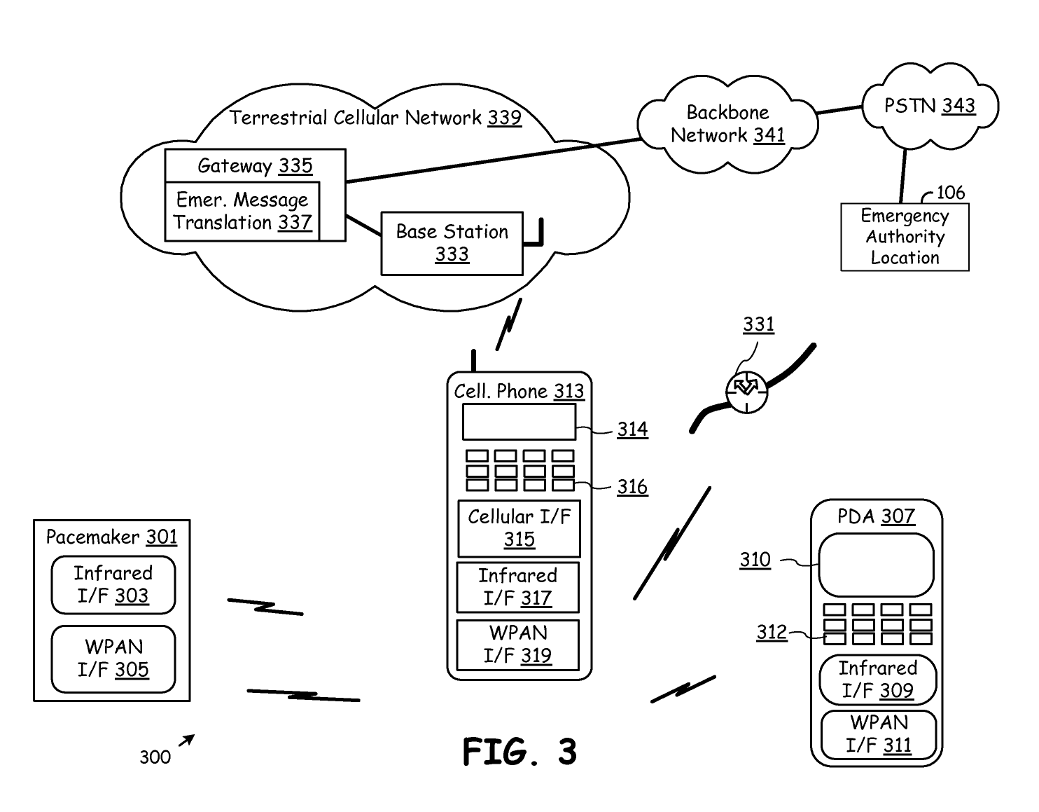

FIG. 3 is a system diagram illustrating a system that supports emergency message generation and relay according to one or more embodiments of the present invention. The system 300 includes a plurality of devices that generate emergency messages, devices that relay emergency messages, and a network infrastructure that services transmission of emergency messages to the emergency authority location 106. For example, pacemaker 301 includes an infrared interface 303 and a WPAN interface 305. Likewise, PDA 307 includes an infrared interface 309 and a WPAN interface 311. Likewise, watch 331 may include a WPAN interface and/or an infrared interface (not shown). Cell phone 313 includes a cellular interface 315, an infrared interface 317, and a WPAN interface 319.

Pacemaker 301 resides within a patient's chest and has the ability to detect a medical emergency condition of the patient. However, the wearer of the pacemaker 301 does not have the ability to independently generate an emergency message direction due to medical emergency and/or may not know that an emergency medical condition exists. In such case, the pacemaker 301 may, based upon measurements of the patient's heart condition, generate an emergency message. In such case, the pacemaker 301 generates the emergency message and transmits the emergency message from both an infrared interface 303 and a WPAN interface 305. However, the pacemaker 301 does not have the ability to couple the emergency message to a cellular network 339 for ultimate delivery to the emergency authority location 106. The cell phone 313 receives the emergency message transmitted by the pacemaker 301 via one or both of its infrared interface 303 and its WPAN interface 305. The cell phone 313 then optionally translates the emergency message and adds location information and/or other information to the emergency message before forwarding the emergency message via the cellular network 339 for delivery to the emergency authority location 106. The emergency authority location 106, based upon the receipt of the emergency message then dispatches emergency service to the wearer of the pacemaker 301. Such dispatch of emergency service may be made based upon an identity of the pacemaker 301 which is included in the emergency message, based upon GPS location information appended to the emergency message by the cell phone 313, and/or other information that would assist in rendering emergency service to a user of the pacemaker 301.

Likewise, the watch 331 or PDA 307 may produce emergency messages and persistently transmit those emergency messages. The watch 331 may have a dedicated emergency button thereon or a sequence of inputs that causes the watch 331 to produce an emergency message via its one or more wireless interfaces. Likewise, the PDA 307 may receive either input from a keypad 312 or touch screen 310 to cause it to generate an emergency message. The emergency message is then persistently transmitted from one or more of its infrared interface 309, its WPAN interface 311 for hopeful receipt by cell phone 313 or another device for subsequent delivery to the terrestrial cellular network 339. In both of these examples, the cell phone 313 receives the emergency messages transmitted by the PDA 307 or the watch 331 and relays the emergency messages to the cellular network 339 for subsequent delivery to emergency authority location 106.

The terrestrial cellular network 339 includes a base station 333 that services communication with cell phone 313. The terrestrial cellular network 339 also includes a gateway 335 that includes emergency message translation functionality 337. The emergency message translation functionality 337 translates emergency messages received from cell phone 313, for example. Gateway 335 of cellular network 339 couples to backbone network 341 that couples to the Public Switched Telephone Network (PSTN) 343, which couples to the emergency authority location 106. The components of the cellular network 339, the backbone network 341, and the PSTN 343 service message transmission between cell phone 313 and emergency authority location 106. This network infrastructure also supports the relay of a response emergency message generated by the emergency authority location 106 to cell phone 313 and ultimately to the source emergency device, e.g., pacemaker 301, watch 331, and/or PDA 307. A communication link may be established between the emergency authority location 106 and a emergency services requesting device such as pacemaker 301, watch 331, or PDA 307. The emergency authority location 106 may also query the source device 301, 331, or 307 for additional information that will assist in dispatch of emergency services in response to the emergency message.

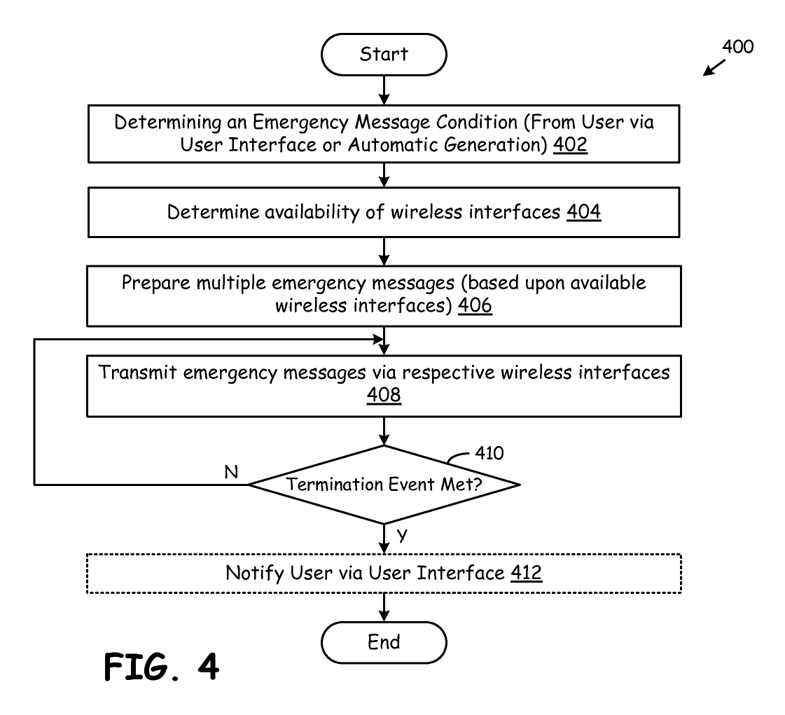

FIG. 4 is a flow chart illustrating operations according to one or more embodiments of the present invention. The operations 400 of FIG. 4 commence with a portable wireless device determining an emergency message condition (Step 402). The emergency message condition may be based upon receipt of an emergency message direction from a user via user interface or, alternatively, the portable wireless device may automatically initiate an emergency message operation based upon the triggering of an emergency event. For example, with reference to FIG. 3, the pacemaker 301 may automatically determine that an emergency condition exists based upon its monitoring of a heart of the user in which the pacemaker 301 is implanted.

After an emergency condition has been detected based upon a direction from a user or another criterion at Step 402, the wireless device determines the availability of wireless interfaces (Step 404). The wireless interfaces that are available may include a WPAN interface, an infrared interface, a millimeter-wave interface, or another type of wireless interface. The wireless device may then prepare multiple emergency messages (based upon the available wireless interfaces) (Step 406). For example, when the wireless device includes both an infrared and a WPAN interface, the wireless device will prepare emergency messages for each of these wireless interfaces.

The wireless device then transmits the emergency messages via the respective wireless interfaces (Step 408). When multiple wireless interfaces are available for transmission of emergency messages, the wireless device transmits the emergency messages via each of the wireless interfaces, e.g., WPAN interface, millimeter-wave interface, infrared interface, etc. The wireless device continues to transmit the emergency messages via the wireless interfaces at Step 408 until a termination event is met (Step 410). The termination event may be the receipt of a response message to the emergency message. Such response message may come from an emergency authority location. Alternatively, the termination event may be another input received from a user indicating that the emergency has either ceased or aid has been rendered. In either case, after the termination event is met, the transmission of emergency messages via the wireless interface ceases and a user may be notified that the termination event has been met. For example, notification at Step 412 to a user is provided when a response is received from the emergency authority location that help is on the way.

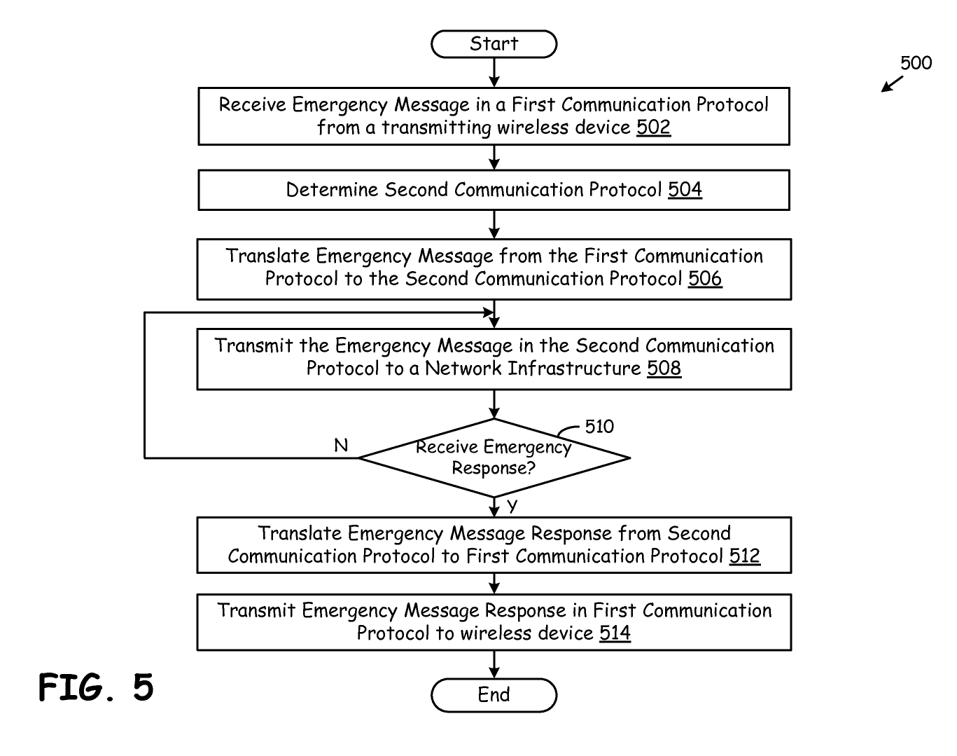

FIG. 5 is a flow chart illustrating message translation operations according to one or more embodiments of the present invention. The operations 500 of FIG. 5 commence with a wireless device, e.g., cell phone 232 of FIG. 2 or a wired device, e.g., emergency message translation function 276 of FIG. 2, receiving an emergency message in a first communication protocol from a transmitting wireless device (Step 502). The wireless device or wired device then determines a second communication protocol that is available for translation of the emergency message (Step 504). The device then translates the emergency message from the first communication protocol to the second communication protocol (Step 506). The first communication protocol differs from the second communication protocol with the second communication protocol consistent with requirements of an emergency authority location 106, in some embodiments.

The wireless device or wired device then transmits the emergency message in the second communication protocol to a network infrastructure (Step 508). The network infrastructure may be a cellular network infrastructure or another network infrastructure that is employed to relay the emergency message eventually to an emergency authority location. Transmission of the emergency message in the second communication protocol to the network infrastructure (Step 508) continues until an emergency response is received (Step 510). After receipt of an emergency response, the wireless or wired device then translates the emergency response from the second communication protocol to the first communication protocol (Step 512). The wired or wireless communication device then transmits the emergency message response in the first communication protocol to the wireless device that initially transmitted the emergency message at Step 502 (Step 514). From Step 514, operation ends.

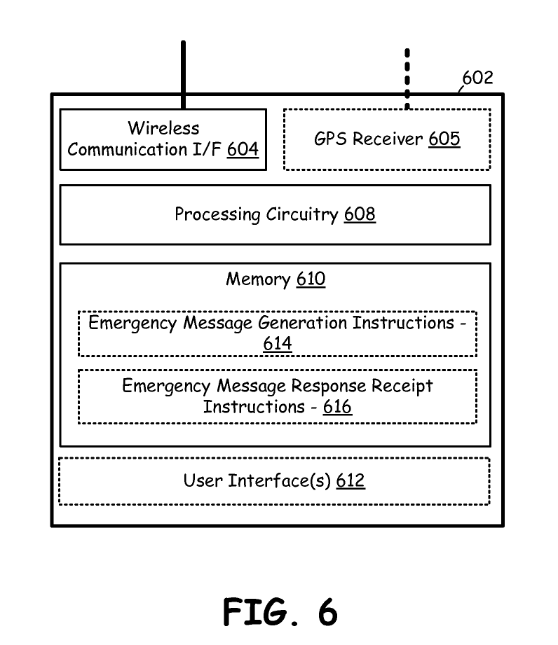

FIG. 6 is a block diagram illustrating a wireless device that generates emergency messages according to one or more embodiment of the present invention. The wireless device 602 of FIG. 6 includes a wireless communication interface 604, optional GPS receiver 605, processing circuitry 608, memory 610, and one or more user interfaces 612. The wireless device 602 of FIG. 6 may be any of personal video recorder 114, laptop computer 116, digital camera 118, video game 120, video player 122, or PDA 124 of FIG. 1. Likewise, the wireless device 602 of FIG. 6 with lesser or greater number of components may be any of pacemaker 301, watch 331, and/or PDA 307 of FIG. 3. The wireless device 602 of FIG. 6 includes one or more communication interfaces 604. These communication interfaces may support WPAN communications, millimeter-wave communications, near field wave communications, infrared wireless communications, or another type of wireless communications. The processing circuitry may be a microprocessor, digital signal processor, custom logic, program logic, or any other type of processing circuitry capable of processing data based upon the execution of software instructions. Memory 610 may be any of RAM, ROM, flash RAM, flash ROM, magnetic memory, optical memory, or any other type of memory capable of storing data and/or instructions. Instructions stored in memory 612 include emergency message generation instructions 614 and emergency message response receipt instructions 616. These software instructions 614 and 616 enable operations according to one or more embodiments of the present invention for generation and transmission of emergency messages via the wireless communication interface 604. The optional user interface 612 may be accessed by user to generate an emergency message direction.

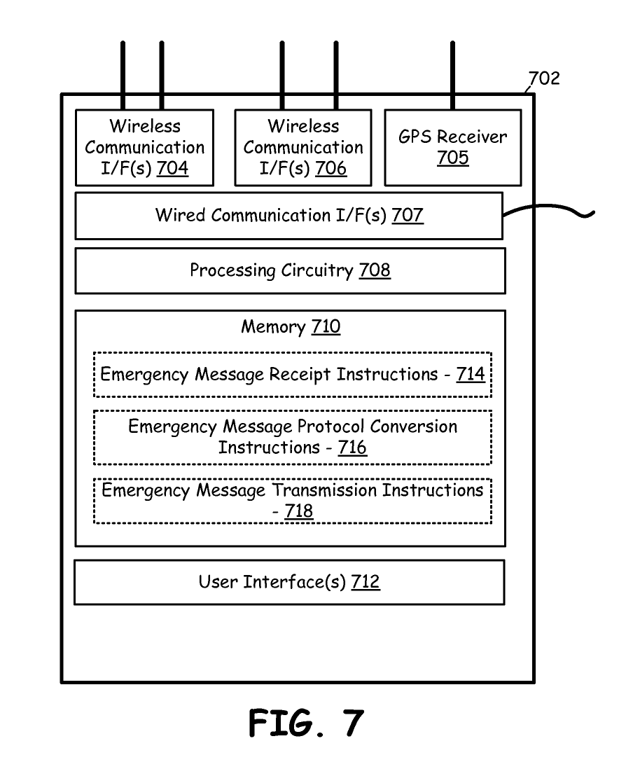

FIG. 7 is a block diagram illustrating a wireless or wired device that performs emergency message conversion according to one or more embodiments of the present invention. The wireless or wired device 702 of FIG. 7 may be any of the WWAN device 108, cell phone 110, communication circuitry contained within vehicle 112 of FIG. 1. Alternatively, the wireless or wired device 702 of FIG. 7 may be the cell phone 232 of FIG. 2 or a component of cellular network 204 of FIG. 2, communications network 102 of FIG. 1, or the cellular network 339 of FIG. 3.

The device 702 of FIG. 7 includes multiple wireless communication interfaces 704 and 706 and may include a wired communications interface 707 a GPS receiver 705. Wireless communications interfaces 704, for example, supports WPAN communications, WLAN communications, millimeter-wave communications, near field wave communications, and/or infrared wireless communications. Likewise, wireless communications interface 706 supports one or more cellular network communications, WWAN communications, and/or satellite communications. The wired communications interface 707 supports wired communications supported by wired media, optical media or other hard media that couples the communications device 702 to a network infrastructure.

Processing circuitry 708 of device 702 may be any of a microprocessor, digital signal processor, custom logic, fixed logic, program logic, or any other type of circuitry that is capable of executing software instructions to process data. Memory 710 includes any type of memory that is capable of storing software instructions and/or data. User interface 712 may include keyboards, mice, displays, or other types of interfaces that support the interaction of the user with the device 702.

Memory 710 stores emergency message receipt instructions 714, emergency message protocol conversion instructions 716, and emergency message transmission instructions 718. These instructions support the various operations previously described herein for the receipt of emergency messages, translation of emergency messages from a first communication protocol to a second communication protocol and vice versa. Further, these software instructions 704, 706, 707 support the operations of the device 702 to relay emergency messages between an emergency authority location 106, and an emergency requesting device.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may include general or specific purpose hardware, or may include such hardware and associated software such as firmware or object code.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “operable to” indicates that an item includes one or more of power connections, input(s), output(s), etc., to perform one or more its corresponding functions and may further include inferred coupling to one or more other items. As may still further be used herein, the term “associated with,” includes direct and/or indirect coupling of separate items and/or one item being embedded within another item. As may be used herein, the term “compares favorably,” indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method for operating a portable wireless device having at least one wireless interface, processing circuitry, and a user interface, the method comprising:
determining an emergency message condition;
preparing at least one emergency message by the processing circuitry based upon the emergency message direction;
repeatedly transmitting the at least one emergency message via the at least one wireless interface; and
upon meeting a termination criteria, ceasing repeatedly transmitting the at least one emergency message via the at least one wireless interface.

2. The method of claim 1, wherein repeatedly transmitting the at least one emergency message via the at least one wireless interface comprises:
transmitting multiple copies of an emergency message in a first format via a first wireless interface; and
transmitting multiple copies of an emergency message in a second format via a second wireless interface that differs from the first wireless interface.

3. The method of claim 2, further comprising transmitting multiple copies of an emergency message in a third format via a third wireless interface that differs from both the first wireless interface and the second wireless interface.

4. The method of claim 1, wherein:
preparing at least one emergency message by the processing circuitry based upon the emergency message direction comprises preparing respective emergency messages for each of a plurality of wireless interfaces; and
repeatedly transmitting the at least one emergency message via the at least one wireless interface comprises transmitting multiple copies of the respective emergency messages via each of the plurality of wireless interfaces.

5. The method of claim 4, wherein transmitting multiple copies of the respective emergency messages via each of the plurality of wireless interfaces comprises one or more of:
transmitting multiple copies of an emergency message in a first format via one of a Wireless Personal Area Network (WPAN) interface, a Wireless Local Area Network (WLAN) interface, a millimeter-wave wireless interface, a near field wave wireless interface, or an infrared wireless interface; and
transmitting multiple copies of an emergency message in a second format via one of a WPAN interface, a WLAN interface, a millimeter-wave wireless interface, a near field wave wireless interface, or an infrared wireless interface that is different from the first wireless interface.

6. The method of claim 1, further comprising receiving an emergency response message via the at least one wireless interface, wherein receiving the emergency response message meets the termination criteria.

7. A wireless device comprising:
a plurality of wireless interfaces, each operable to support wireless communications according to a respective communication protocol standard;
memory;
a user interface;
processing circuitry coupled to the plurality of wireless interfaces, the memory, and to the user interface, wherein the processing circuitry is operable to:
determining an emergency message condition;
prepare at least one emergency message by the processing circuitry based upon the emergency message direction;
repeatedly transmit the at least one emergency message via the at least one wireless interface; and
upon meeting a termination criteria, cease repeatedly transmitting the at least one emergency message via the at least one wireless interface.

8. The wireless device of claim 7, wherein in repeatedly transmitting the at least one emergency message via the at least one wireless interface, the processing circuitry is operable to:
transmit multiple copies of an emergency message in a first format via a first wireless interface; and
transmit multiple copies of an emergency message in a second format via a second wireless interface that differs from the first wireless interface.

9. The wireless device of claim 8, wherein the processing circuitry is further operable to transmit multiple copies of an emergency message in a third format via a third wireless interface of the plurality of wireless interfaces that differs from both the first wireless interface and the second wireless interface.

10. The wireless device of claim 7, wherein:
preparing at least one emergency message by the processing circuitry based upon the emergency message direction comprises preparing respective emergency messages for each of a plurality of wireless interfaces; and
repeatedly transmitting the at least one emergency message via the at least one wireless interface comprises transmitting multiple copies of the respective emergency messages via each of the plurality of wireless interfaces.

11. The wireless device of claim 10, wherein transmitting multiple copies of the respective emergency messages via each of the plurality of wireless interfaces comprises one or more of:
transmitting multiple copies of an emergency message in a first format via one of a Wireless Personal Area Network (WPAN) interface, a Wireless Local Area Network (WLAN) interface, a millimeter-wave wireless interface, a near field wave wireless interface, or an infrared wireless interface; and
transmitting multiple copies of an emergency message in a second format via one of a WPAN interface, a WLAN interface, a millimeter-wave wireless interface, a near field wave wireless interface, or an infrared wireless interface that is different from the first wireless interface.

12. The wireless device of claim 7, wherein the processing circuitry is further operable to receive an emergency response message via the at least one wireless interface, wherein receiving the emergency response message meets the termination criteria.

13. A method for servicing emergency messages by a wireless device comprising:
receiving a first emergency message in a first communication protocol via a first wireless interface from a transmitting wireless device;
translating the first emergency message in the first communication protocol to a second emergency message in a second communication protocol; and
transmitting the second emergency message in the second communication protocol to a network infrastructure via a second wireless interface.

14. The method of claim 13, wherein:
the first wireless interface supports communications with one of a Wireless Personal Area Network (WPAN), a Wireless Local Area Network (WLAN), a millimeter-wave communication device, a near field wave wireless communication device, or an infrared wireless communication device; and
the second wireless interface supports communications with one or more of a cellular network and a Wireless Wide Area Network (WWAN).

15. The method of claim 13, further comprising:
receiving an emergency response message in the second communication protocol via the second wireless interface from the network infrastructure;
translating the emergency response message in the second communication protocol to an emergency response message in the first communication protocol; and
transmitting the emergency message in the first communication protocol to the second wireless device.

16. A wireless device comprising:
a plurality of wireless interfaces, each operable to support wireless communications according to a respective communication protocol standard;
memory;
a user interface;
processing circuitry coupled to the plurality of wireless interfaces, the memory, and to the user interface, wherein the processing circuitry is operable to:
receive a first emergency message in a first communication protocol via a first wireless interface of the plurality of wireless interfaces from a transmitting wireless device;
translate the first emergency message in the first communication protocol to a second emergency message in a second communication protocol; and
transmit the second emergency message in the second communication protocol via a second wireless interface of the plurality of wireless interfaces to a network infrastructure.

17. The wireless device of claim 16, wherein:
the first wireless interface supports communications with one of a Wireless Personal Area Network (WPAN), a Wireless Local Area Network (WLAN), a millimeter-wave communication device, a near field wave wireless communication device, or an infrared wireless communication device; and
the second wireless interface supports communications with one or more of a cellular network and a Wireless Wide Area Network (WWAN).

18. The wireless device of claim 16, wherein the processing circuitry is further operable to:
receive an emergency response message in the second communication protocol via the second wireless interface from the network infrastructure;
translate the emergency response message in the second communication protocol to an emergency response message in the first communication protocol; and
transmit the emergency message in the first communication protocol to the transmitting wireless device.

19. A communication device comprising:
at least one wireless interface operable to support wireless communications according to a respective communication protocol standard;
at least one wired interface operable to support wired communications according to a respective communication protocol standard;
memory;
a user interface;
processing circuitry coupled to the at least one wireless interface, the at least one wired interface, the memory, and to the user interface, wherein the processing circuitry is operable to:
receive a first emergency message in a first communication protocol via the at least one wireless interface from a transmitting wireless device;
translate the first emergency message in the first communication protocol to a second emergency message in a second communication protocol; and
transmit the second emergency message in the second communication protocol via the at least one wired interface to a network infrastructure.

20. The communication device of claim 19, wherein the processing circuitry is further operable to:
receive an emergency response message in the second communication protocol via the wired interface from the network infrastructure;
translate the emergency response message in the second communication protocol to an emergency response message in the first communication protocol; and
transmit the emergency message in the first communication protocol to the transmitting wireless device.
